(19) United States
(12) Patent Application Publication
(10) Pub. No.: US 2016/0012340 A1
(43) Pub. Date: Jan. 14, 2016

(54) TEMPERATURE-BASED ESTIMATION OF BUILDING OCCUPANCY STATES

(71) Applicant: The Regents of the University of California, Oakland, CA (US)

(72) Inventors: Michael V. Georgescu, Van Nuys, CA (US); Igor Mezic, Goleta, CA (US)

(73) Assignee: The Regents of the University of California, Oakland, CA (US)

(21) Appl. No.: 14/327,292

(22) Filed: Jul. 9, 2014

(51) Int. Cl. G06N 5/04; G05F 1/66; G05B 15/02

(52) U.S. Cl. CPC G06N 5/048; G05B 15/02; G05F 1/66

(57) ABSTRACT

Systems and methods are disclosed for the generation of more accurate usage profiles for use in the modeling of existing buildings. Building sensor data associated with individual rooms in a building can be decomposed using wavelets to identify features that correspond to heat loads generated by occupant presence and/or equipment operation. From this information, the occupancy state of individual rooms can be estimated. The estimated occupancy state for the individual rooms in the building then can be used to generate a usage profile for the building. The usage profile can be used to estimate current and/or future energy usage or costs or to control equipment in the building at a current and/or future time.

### TECHNICAL FIELD

The systems and methods disclosed herein relate generally to estimating occupancy states of a building using building sensor information.

### BACKGROUND

Office buildings consume 40% of the energy used in the United States, and 70% of the electricity used in the United States. Energy consumption—whether electrical, fossil fuel, or other energy usage—has become a topic of concern not only for the efficient use of resources, but also because of its global impact.

Since interest in the efficient use of energy is high, technologies and tools that aid designers or building owners in providing comfortable, clean, and efficient buildings have been in use for many years. For example, a growing sector of the building systems community has focused on modeling existing buildings. In the past several years, applications using models of existing buildings have included retrofit studies, failure mode analyses, and predictive control models. Often, the models are based on defined usage profiles, which attempt to capture the behavior or performance of the building at issue.

Despite current capabilities, the building systems community has found it difficult to define usage profiles when modeling existing buildings. Conventionally, building simulation software expects usage profiles to be predefined hourly based on knowledge of how a building to be modeled should ideally operate in an assumed setting. This approach, however, can lead to less accurate results. In particular, this approach can create a mismatch in behavior between an actual building and a modeled building.

### SUMMARY

Accordingly, systems and methods for the generation of more accurate usage profiles for use in the modeling of existing buildings are disclosed herein. Building sensor data associated with individual rooms in a building can be decomposed using wavelets to identify features that correspond to heat loads generated by occupant presence and/or equipment operation. From this information, the occupancy state of individual rooms can be estimated. The estimated occupancy state for the individual rooms in the building then can be used to generate a usage profile for the building. The usage profile for the building can be used for a variety of purposes. For example, the usage profile can be used to estimate current and/or future energy usage or costs. As another example, the usage profile can be used to control equipment in the building (e.g., heating, ventilation, and air conditioning (HVAC) systems, fans, cooling coils, chillers and boilers, electric components, gas components, cooling towers, water systems, lighting equipment, etc.) at a current and/or future time.

One aspect of the disclosure provides a method for predicting energy usage in a building. The method comprises, as implemented by a computer system comprising one or more computing devices, the computer system configured with specific executable instructions, receiving temperature data corresponding to a room in the building. The temperature data may comprise a plurality of temperature measurements taken at different respective points in time. The method further comprises analyzing the received temperature data in a time-scale domain. The method further comprises estimating an occupancy state of the room in the building based on the analysis of the received temperature data. The occupancy state of the room in the building may indicate whether the room is occupied or vacant.

Another aspect of the disclosure provides an electronic apparatus for predicting energy usage in a building. The apparatus comprises a computer data repository configured to store a data set, the data set comprising building sensor data, the building sensor data comprising a plurality of values captured over time for a room in the building. The apparatus further comprises a computing system comprising one or more computing devices, the computing system in communication with the computer data repository and programmed to implement a sensor data analyzer configured to retrieve and analyze the building sensor data. The computing system may be further programmed to implement an occupancy estimator configured to estimate an occupancy state of the room in the building based on the analysis of the building sensor data. The computing system may be further programmed to implement a usage profile builder configured to generate a usage profile for the building based on the estimated occupancy state.

Another aspect of the disclosure provides a computer storage system comprising a non-transitory storage device, said computer storage system having stored thereon executable program instructions that direct a computer system to at least receive building sensor data corresponding to a room in a building. The computer storage system further has stored thereon executable program instructions that direct a computer system to at least analyze the received building sensor data. The computer storage system further has stored thereon executable program instructions that direct a computer system to at least estimate an occupancy state of the room in the building based on the analysis of the received building sensor data. The computer storage system further has stored thereon executable program instructions that direct a computer system to at least generate a usage profile for the building based on the estimated occupancy state. The computer storage system further has stored thereon executable program instructions that direct a computer system to at least generate a model of predicted energy consumption for the building based on the generated usage profile.

### BRIEF DESCRIPTION OF THE DRAWINGS

FIG. 1 illustrates a cutaway perspective of a building comprising a plurality of environment and energy affecting components, as well as various building sensors configured to monitor the building's behavior.

FIG. 2 illustrates a floor plan of a building, such as the building of FIG. 1.

FIG. 3A depicts a generalized logical flow diagram illustrating how an analysis of the building sensor data can be used to estimate occupancy states and present a visualization of the results of the analysis to a user.

FIG. 3B depicts another generalized logical flow diagram illustrating how an analysis of the building sensor data can be used to estimate occupancy states and implement a feedback system.

FIG. 4 illustrates a block diagram of a building occupancy state estimation environment.

FIG. 5 illustrates a graph of exemplary temperature measurements for a room in a building and for the outdoors.

FIGS. 6A-6B illustrate exemplary spectrograms of the CWT calculated from the temperature measurements for the room in the building and for the outdoors as presented in FIG. 5.

FIG. 7 illustrates an exemplary graph indicating the occupancy states for sixty five rooms in a building, such as the building of FIG. 1.

FIG. 8 illustrates an exemplary PMF for the days for which an occupancy state has been estimated.

FIG. 9 illustrates an exemplary graph comparing the percentage difference between the actual electric consumption and electric consumption estimated using the reference usage profile and between the actual electronic consumption and electric consumption estimated using the modified usage profile.

FIG. 10 illustrates a process for predicting energy usage in a building.

### DETAILED DESCRIPTION OF SPECIFIC EMBODIMENTS

### Introduction

As described above, usage profiles, which attempt to capture the behavior or performance of a building at issue, can be used to model an existing building. Furthermore, conventional building simulation software expects usage profiles to be predefined hourly based on knowledge of how a building to be modeled should ideally operate in an assumed setting. While the usage profiles are defined hourly, the usage profiles are repetitive in the sense that their shapes are periodic, typically from week to week. Although it is known that such usage profiles lead to less accurate models, the usage profiles have been generally accepted because detailed knowledge of building operations is usually unknown. The models could be improved, however, if the usage profiles captured the energy consuming and thermal effects from processes like occupancy, lighting, and/or equipment operation within a building.

Accordingly, more accurate systems and methods for the generation of usage profiles for use in the modeling of existing buildings are described herein. In an embodiment, by decomposing building sensor data (e.g., building temperature data) of individual rooms using wavelets, features can be identified that correspond to heat loads generated by occupant presence and/or equipment operation. From this information, the occupancy state (e.g., the status of a room being occupied or vacant, a number of people occupying a room, etc.) can be estimated. As used herein, a room is considered occupied if at least one person occupies the room. A room may be considered fully occupied if a number of people occupying the room meets or exceeds a maximum occupancy associated with the room. A room may be considered partially occupied if a number of people occupying the room is greater than zero and less than the maximum occupancy associated with the room. The estimated occupancy state for one or more rooms in a building then can be used to generate a usage profile for the building. The usage profile for the building can be used for a variety of purposes. For example, the usage profile can be used to estimate current and/or future energy usage or costs. As another example, the usage profile can be used to control equipment in the building (e.g., heating, ventilation, and air conditioning (HVAC) systems, fans, cooling coils, chillers and boilers, electric components, gas components, cooling towers, water systems, lighting equipment, etc.) at a current and/or future time.

### Example Building and Floor Plan

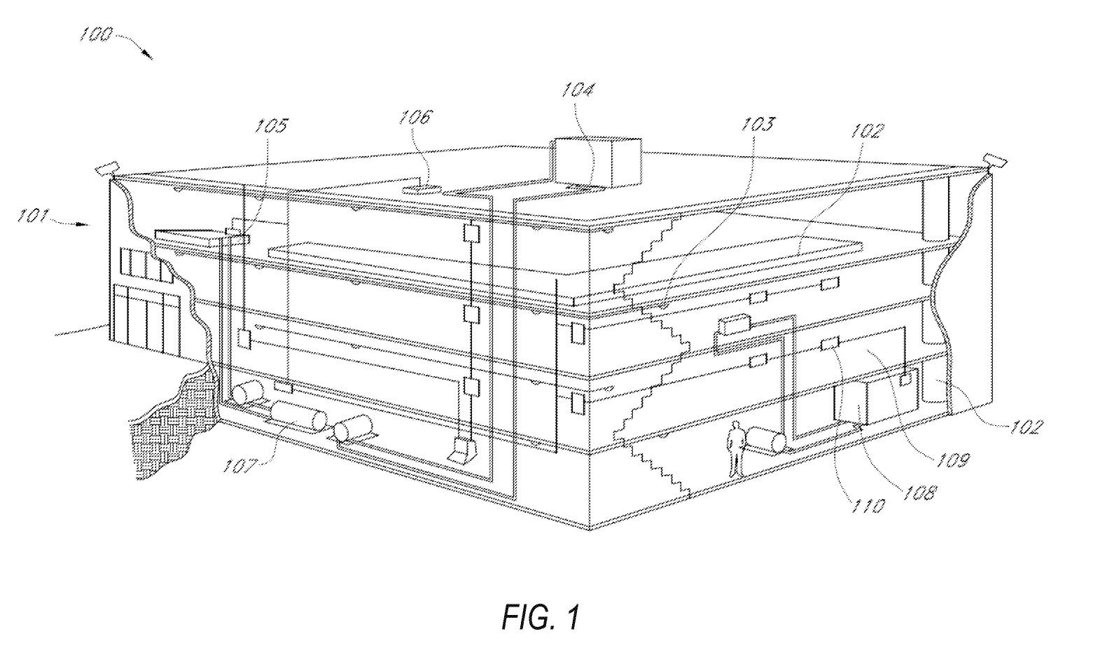

FIG. 1 illustrates a cutaway perspective 100 of a building 101 comprising a plurality of environment and energy affecting components, as well as various building sensors configured to monitor the building's behavior. Particularly, the building may comprise electric, gas, and heating components 102, cooling towers 104, lighting 103, water systems 109 and other utilities. Some components, such as the cooling coils 105, fans 106, and chillers and boilers 107, may be operated to adjust the internal temperature of various rooms of the building 101. Sensors, such as thermostats and humidistats, may be present and operate locally within the building. Some sensors may transmit their data to and be activated from a central office or control system.

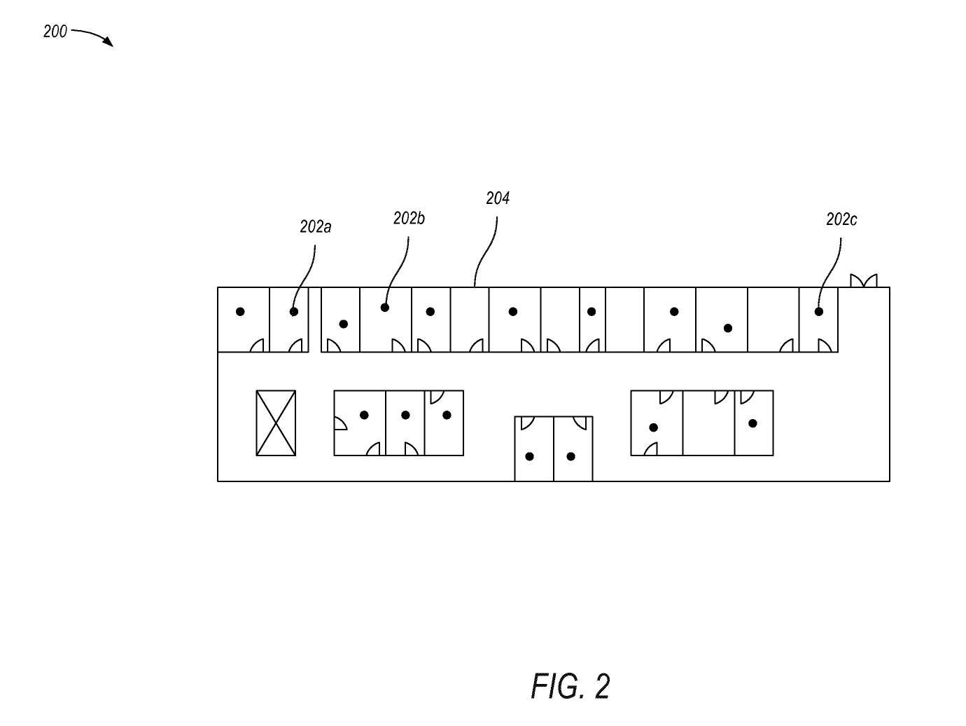

FIG. 2 illustrates a floor plan 200 of a building, such as the building 101. Although shown here as a two-dimensional, top-down view of a single floor, one will recognize a plurality of other possible representations (e.g., a three-dimensional depiction of a multi-story architecture). Illustrated on the floor plan 200 are the locations of a number of sensors 202a-c. In some embodiments, each room in the building 101 includes a sensor 202a-c. In other embodiments, some rooms in the building 101 include a sensor 202a-c and other rooms in the building 101 do not include a sensor 202a-c. For example, as illustrated in FIG. 2, a room 204 does not include a sensor 202a-c.

Each of these sensors 202a-c may measure one or more properties of the building at their particular location. For example, the sensors 202a-c may measure temperature, humidity, gases (e.g., carbon monoxide, carbon dioxide, etc.), lighting usage (e.g., when and for how long lights are in use), motion (e.g., whether there is movement by an object in the general vicinity of the sensor 202a-c), air flow, electric power, smoke, and/or the like. The data captured by the sensors 202a-c may be converted to an appropriate form to facilitate analysis. For example, a sensor 202a-c may record the temperature or the humidity. As another example, a sensor 202a-c may record a change in temperature, a change in humidity, or an integral of these values over a period of time. Alternatively, a computer system can perform this post-processing on the raw sensor data.

Each sensor 202a-c may store information locally and/or may transmit the information to a central system. Those sensors 202a-c that transmit their information may do so via a wired or wireless network. Certain embodiments contemplate the sensors 202a-c as comprising an ad-hoc infrastructure that facilitates the transmission of readings to a central system. In certain embodiments comprising wireless sensors 202a-c, routers or other such data transmission equipment may be used to collect data from the sensors 202a-c and pass them on to the central system.

As described below, once the data has been acquired from the sensors 202a-c, occupancy states and usage profiles can be determined by a data processing system within the central system, such as a sensor data analysis system described below. The data processing system may comprise a computing device having a processor and a memory. This system may be in the form of a personal computer or a cluster computer, may involve computing devices in the computing cloud, may be implemented as an embedded system, and/or may be in other forms that contain the basic processing and memory units. Certain embodiments contemplate data processing software that may run on the data processing hardware of the data processing system.

### Occupancy State Estimation Overview

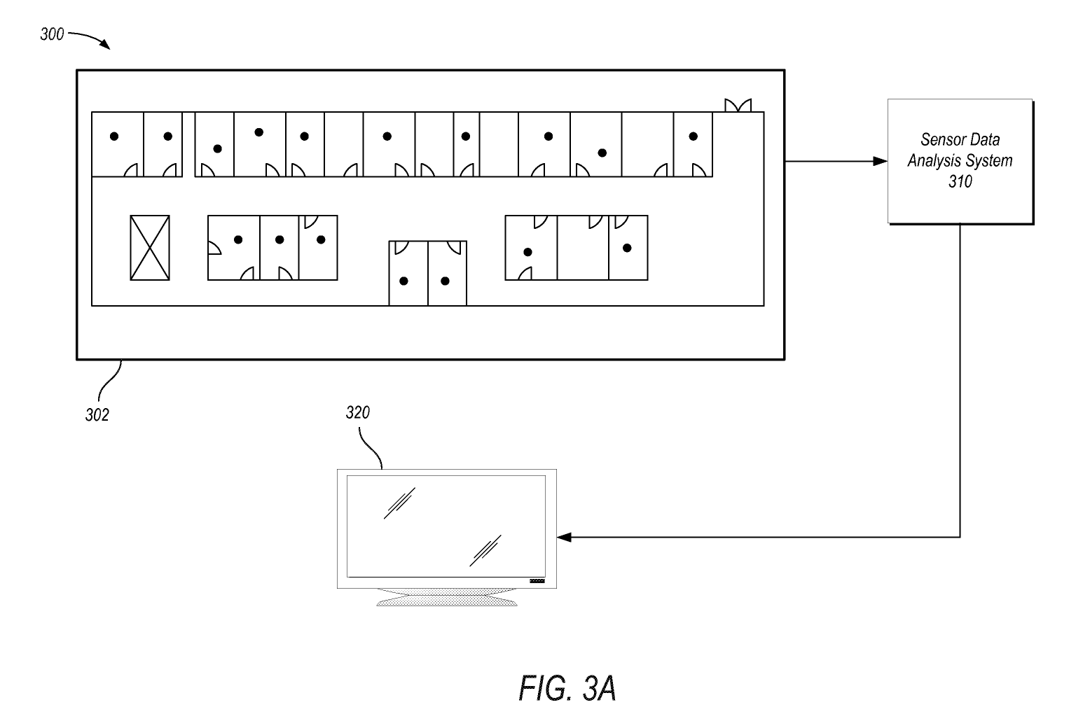

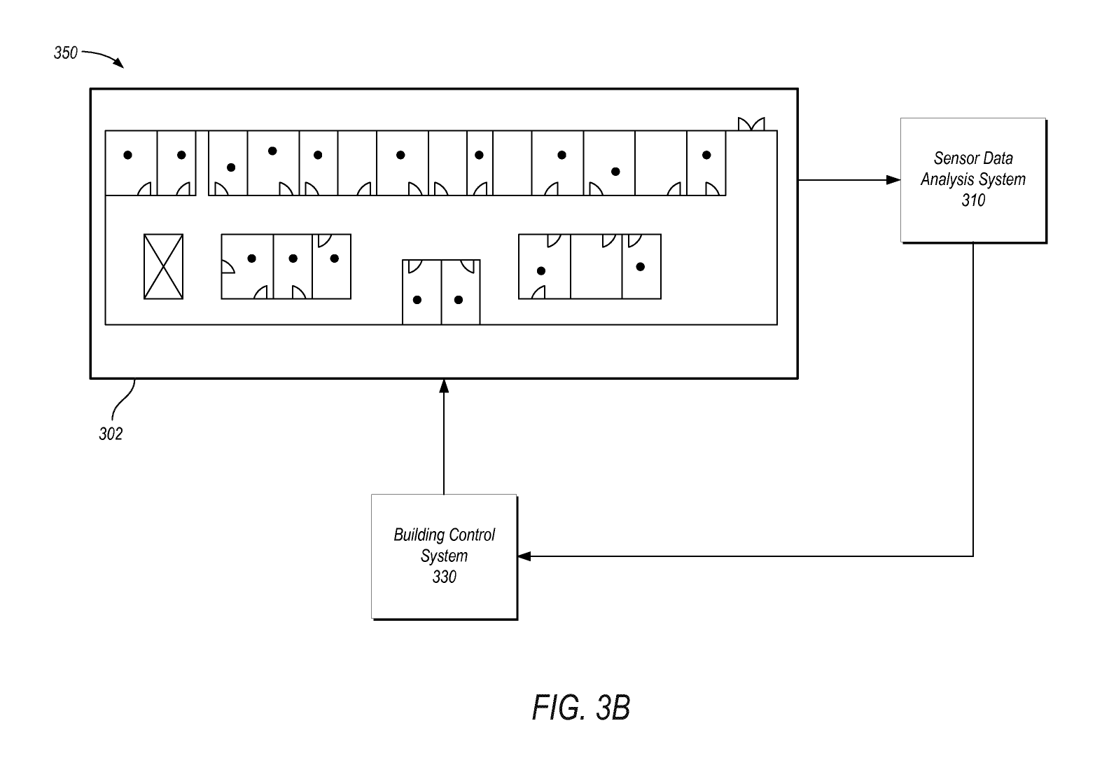

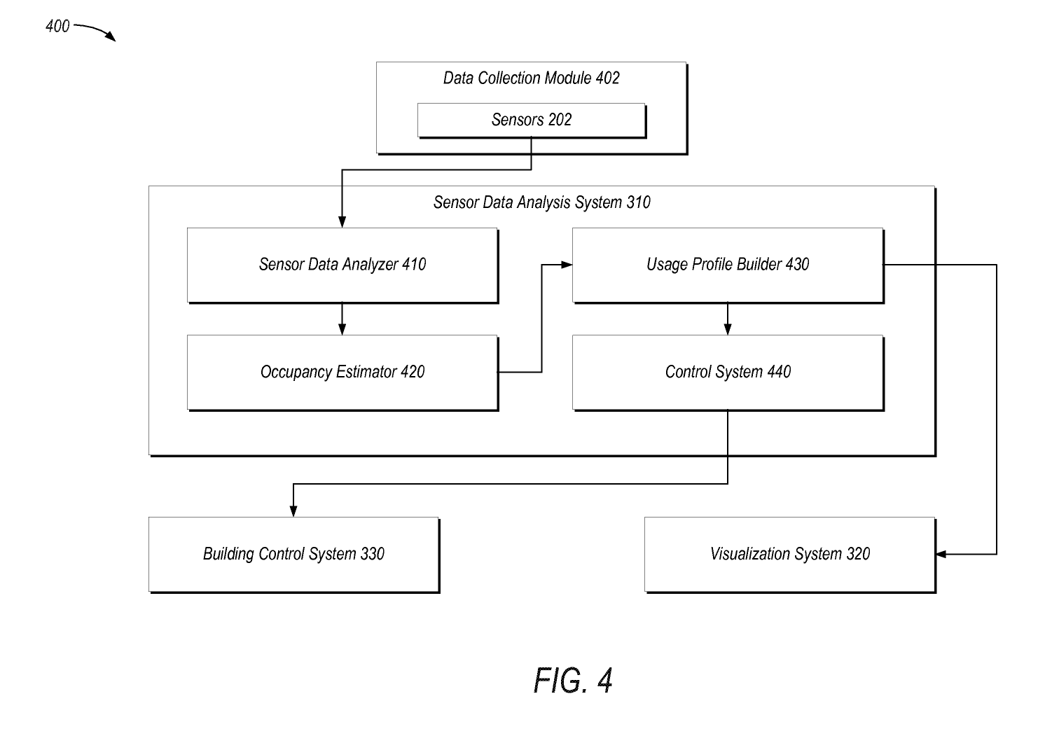

FIG. 3A depicts a generalized logical flow diagram 300 illustrating how an analysis of the building sensor data can be used to estimate occupancy states and present a visualization of the results of the analysis to a user. As illustrated in FIG. 3A, the flow diagram 300 includes a sensor data analysis system 310. The sensor data analysis system 310 can be a computing system configured to estimate occupancy states for one or more buildings and generate visualizations or commands based on the estimates, as described in greater detail below with respect to FIG. 4. In some embodiments, the sensor data analysis system 310 may include various modules, components, data stores, and the like to provide the functionality described herein. Although FIG. 3A depicts a single sensor data analysis system 310, the functions described herein may be performed or distributed across multiple networked computing devices, including devices that are geographically distributed and/or are allocated dynamically from a pool of cloud computing resources. Some or all of the computing devices of the sensor data analysis system 310 may be remote from the building or buildings being analyzed. For example, the sensor data analysis system 310 can be implemented by one more virtual machines in a hosted computing environment. The hosted computing environment may include one or more rapidly provisioned and released computing resources (e.g., dynamically-allocated computing resources), which computing resources may include computing, networking and/or storage devices.

In an embodiment, the sensor data analysis system 310 acquires sensor data 302 from a building, such as the building 101 of FIG. 1. For example, the sensor data analysis system 310 may acquire the sensor data 302 from the sensors 202a-c of FIG. 2. As described above, the sensor data analysis system 310 may acquire the sensor data 302 directly from the sensors 202a-c (e.g., via a wired or wireless connection) or indirectly from the sensors 202a-c via a network (not shown). The network may be a wired network, a wireless network, or a combination of the two. For example, the network may be a personal area network, a local area network (LAN), a wide area network (WAN), or combinations of the same. In addition, the network may be an over-the-air broadcast network (e.g., for radio or television) or a publicly accessible network of linked networks, possibly operated by various distinct parties, such as the Internet. In some embodiments, the network may be a private or semi-private network, such as a corporate or university intranet. The network may include one or more wireless networks, such as a Global System for Mobile Communications (GSM) network, a Code Division Multiple Access (CDMA) network, a Long Term Evolution (LTE) network, or any other type of wireless network. Protocols and components for communicating via any of the other aforementioned types of communication networks, such as the TCP/IP protocols, can be used in the network. Protocols and components for communicating via the Internet or any of the other aforementioned types of communication networks are well known to those skilled in the art of computer communications and thus, need not be described in more detail herein.

The sensor data analysis system 310 can then analyze the sensor data 302 in a manner as described in greater detail below with respect to FIG. 4. The sensor data analysis system 310 may then produce a visual representation of the analysis that is provided to a visualization system 320. The visualization system 320 may include a screen, such as a touch interface, a monitor, a television, and/or the like, to display the visual representation. As an example, the visual representation may include a representation of the occupancy state of the building over a period of time. As another example, the visual representation may include a representation of the usage profile of the building. As another example, the visual representation may include a prediction of the energy usage and/or energy cost of the building at a current or future time.

FIG. 3B depicts another generalized logical flow diagram 350 illustrating how an analysis of the building sensor data can be used to estimate occupancy states and implement a feedback system. As illustrated in FIG. 3B, the sensor data analysis system 310 provides commands to a building control system 330 based on the analysis of the sensor data 302. The building control system 330 may include a device that controls equipment associated with the building being analyzed. For example, the building control system 330 may supply commands to HVAC systems, fans, cooling coils, chillers and boilers, electric components, gas components, cooling towers, water systems, lighting equipment, and/or the like. The commands may be supplied to such equipment to control the temperature in one or more rooms of the building at a current or future time. The sensor data analysis system 310 may provide the commands to the building control system 330 directly using a wired or wireless connection or indirectly, such as via a network.

FIG. 4 illustrates a block diagram of a building occupancy state estimation environment 400. As illustrated in FIG. 4, the environment 400 includes a data collection module 402, the sensor data analysis system 310, the visualization system 320, and/or the building control system 330. As described herein, the sensor data analysis system 310 may use a wavelet analysis to estimate the occupancy states of a building and generate the described outputs. For example, building heat transfer may occur at multiple time-scales and may be driven by internal and external sources. A building can experience heat loads that change slowly over months (e.g., seasonal changes) or that change over minutes (e.g., because of HVAC control loops). Using wavelet analysis, a given temperature response can be decomposed into wavelets that allow for the sensor data analysis system 310 to analyze time and scale-specific features of the response.

Wavelet transformations can be inner products of a square-integrable signal with a family of certain basis functions derived from what is known as a mother wavelet. Using a time-domain signal x(t), the sensor data analysis system 310 can generate a transformation that moves data into a time-frequency representation. For example, the transformation could be a time-frequency transformation, such as a continuous wavelet transformation (CWT), a discrete wavelet transformation, a short-time Fourier transformation, and/or the like. For the purposes of simplicity, the techniques disclosed herein are described in relation to the use of a CWT. However, any time-frequency transformation may be used in conjunction with the techniques disclosed herein. As an example, a CWT can be expressed by the following integral:

$${X}_{ω} ( a , b ) = \frac{1}{\sqrt{\vert a \vert}} {\int }_{- ∞}^{∞} x ( t ) ψ * ( \frac{t - b}{a} ) d t \qquad ( 1 )$$

In Equation (1), the term ψ(t) can be a continuous function in the time and scale domain known as the mother wavelet and * represents complex conjugation. The basis functions of the transformation in Equation (1) can be a translated and scaled version of the mother wavelet ψ expressed as the following:

$${ψ}_{a , b} ( t ) = \frac{1}{\sqrt{\vert a \vert}} ψ ( \frac{t - b}{a} ) \qquad ( 2 )$$

In Equation (2), the parameter a can be a scale factor and the parameter b can be a time location. The CWT, X_{ω}(a,b), can provide information of x(t) at scales relating to the parameter a and the temporal location given by the parameter b. An alternate conceptualization can be that X_{ω}(a,b) is the convolution of x(t) with the wavelet function ψ_{a,b}(t). Because of this, the sensor data analysis system 310 can calculate the CWT using a Fast Fourier Transformation (FFT).

In an embodiment, the sensor data analysis system 310 can use one of many functions ψ(t) in the wavelet analysis. For example, the mother wavelet may be a Meyer wavelet, a Morlet wavelet, a Mexican Hat wavelet, and/or the like. For convenience, this disclosure describes the mother wavelet as being a Morlet wavelet. The general form of the Morlet wavelet can be given by the following function:

$$\begin{matrix}{ψ}_{σ} ( t ) = {c}_{σ} {π}^{- \frac{1}{4}} {e}^{- \frac{1}{2} {t}^{2}} ( {e}^{iσ t} - {e}^{- \frac{1}{2} {σ}^{2}} ) \\ where & ( 3 ) \\ {c}_{σ} = {( 1 + {e}^{- {σ}^{2}} - 2 {e}^{- \frac{3}{4} {σ}^{2}} )}^{- \frac{1}{2}} & ( 4 )\end{matrix}$$

The Morlet wavelet can be a sinusoid with a Gaussian window. The sensor data analysis system 310 may select the envelope factor, a, so that Equation (3) becomes the following:

$${ψ}_{σ} ( t ) = {e}^{- \frac{{t}^{2}}{2}} cos ( 5 t ) \qquad ( 5 )$$

Use of the Morlet wavelet by the sensor data analysis system 310 may be beneficial because the contribution of different frequencies present in an input signal may be kept reasonably separated in its decomposition. Because building temperature data can be periodic in nature, the separation of the contribution of different frequencies may allow features at different scales to be distinguishable.

As described in greater detail below, the sensor data analysis system 310 uses the calculated CWT to estimate occupancy states of measured rooms in an existing building. As described above, the occupancy state corresponds to whether a room has (or has not) been occupied for a particular time period (e.g., an hour, a day, a week, etc.). Generally, when occupants are present in a room for a sufficient length of time, effects can be seen in the decomposed wavelets of the room temperature response. The observed effects may not be due to other processes. By estimating occupancy states using this approach, the sensor data analysis system 310 can generate usage profiles that can be applied to the existing building. This approach may more realistically capture the complex behavior of occupants and process loads when modeling an existing building.

The data collection module 402 may be a device, such as a computing device, that collects the sensor data 302. For example, the data collection module 402 may collect the sensor data 302 from the sensors 202a-c of the building 101.

In an embodiment, the sensor data analysis system 310 includes a sensor data analyzer 410, an occupancy estimator 420, a usage profile builder 430, and a control system 440. The data collection module 402 may transmit the collected sensor data 302 to the sensor data analyzer 410. In addition, the sensor data analyzer 410 may receive other data, such as outdoor temperature, outside humidity, wind speed, wind direction, solar radiation, and/or the like. The sensor data analyzer 410 may analyze the sensor data 302 (and/or other received data) in a time-scale domain (e.g., a representation in which data can be analyzed or studied in both the time domain and frequency domain simultaneously) by generating the CWT described above. For example, the sensor data analyzer 410 may generate a CWT of a temperature response for one or more rooms in the building using the sensor data 302. A different CWT may be generated for each sensor (or room) from which data is received. In some embodiments, if the sensor data 302 does not include temperature values, the sensor data analyzer 410 performs a conversion to convert the sensor data 302 into temperature values (e.g., the sensor data analyzer 410 converts humidity values into temperature values) before generating the CWT.

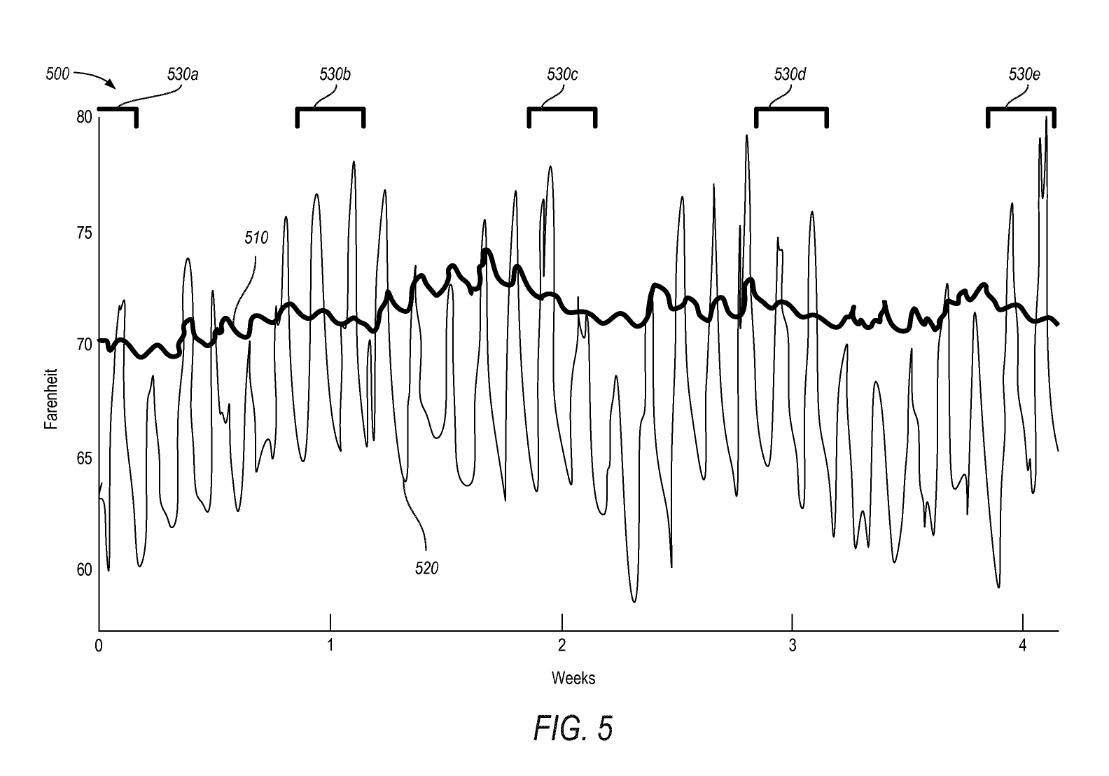

FIG. 5 illustrates a graph 500 of exemplary temperature measurements for a room in a building and for the outdoors. As illustrated in FIG. 5, the temperature is measured over a four week period. The room temperature, illustrated by line 510, varies from approximately 70° F. to approximately 74° F., whereas the outside temperature, illustrated by line 520, varies from approximately 60° F. to approximately 80° F. The sensor data analyzer 410 may receive the room temperature before generating the CWT. In an embodiment, the variation in the outside temperature during weekends 530a-e corresponds with variations in the outside temperature during times outside of the weekends 530a-e (e.g., weekdays). However, the variation in the room temperature during the weekends 530a-e is different than the variation in the room temperature during weekdays. In particular, as indicated by the line 510, the room temperature trends downward during the weekends 530a-e.

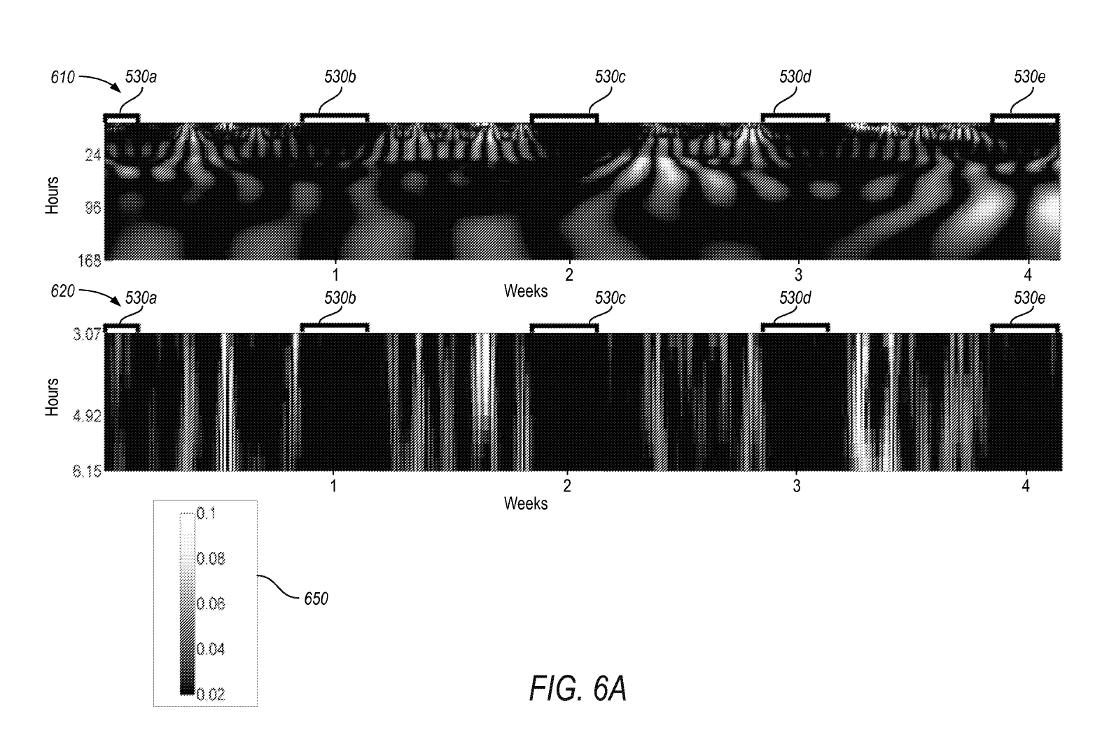

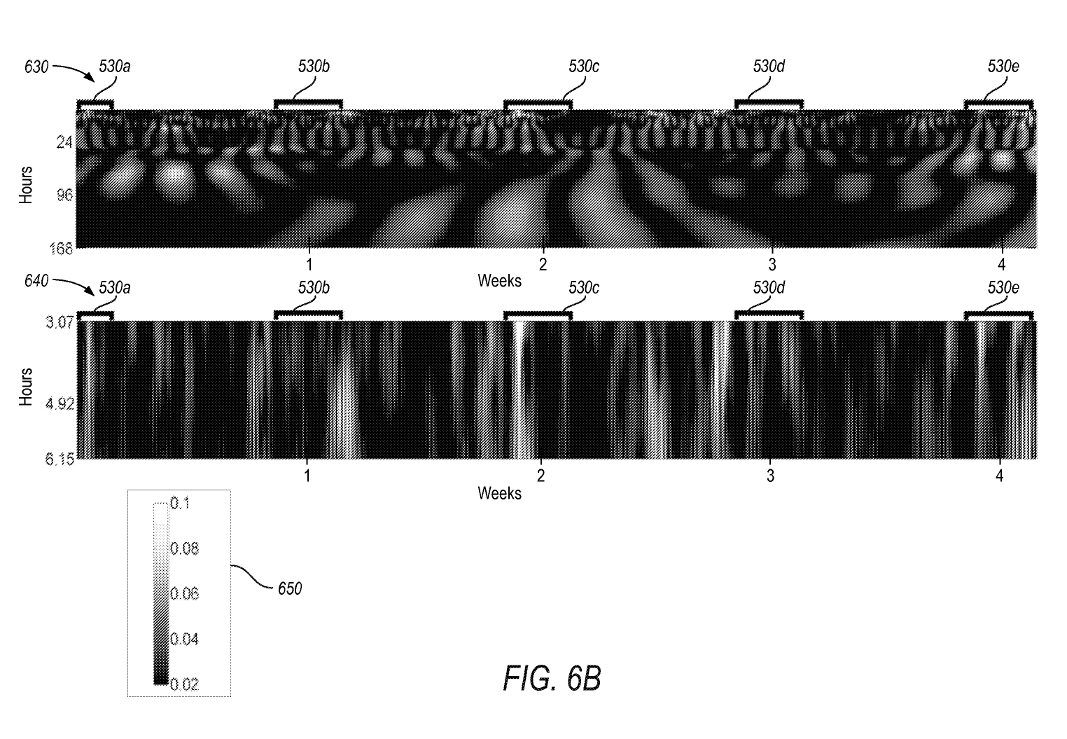

FIGS. 6A-6B illustrate exemplary spectrograms 610, 620, 630, and 640 of the CWT calculated from the temperature measurements for the room in the building and for the outdoors as presented in FIG. 5. As used herein, a spectrogram illustrates magnitude, scale, and position in time of wavelets used to decompose a signal. The spectrograms 610, 620, 630, and 640 illustrate the CWT over the same time period as the temperature measurements illustrated in the graph 500. Legend 650 indicates a normalized scale of energy of the CWT as a percentage (e.g., lighter shades indicate a high spectral energy and darker shades indicate a lower spectral energy).

As an example, the spectrograms 610 and 620 illustrate the CWT of a naturally ventilated room (e.g., a room that includes manually-operated baseboard heating, but otherwise has no control of temperature). The spectrograms 630 and 640 illustrate the CWT of outdoor air temperature. The spectrograms 610 and 630 illustrate the CWT over a pseudo-period of 0 to 168 hours, whereas the spectrograms 620 and 640 illustrate the CWT over a pseudo-period of 3.07 to 6.15 hours. Because wavelets are of finite duration, the concept of frequency may not directly apply. However, because the Morlet wavelet used by the sensor data analyzer 410 in the decomposition can have a frequency response constrained to a narrow range of frequencies, the concept of a pseudo-frequency can be applied. Thus, the spectrograms 610, 620, 630, and 640 are illustrated with respect to pseudo-periods. The pseudo-frequency and pseudo-period of a wavelet scale can be defined as

$${f}_{a} = \frac{{f}_{c}}{a Δ} {T}_{a} = \frac{1}{{f}_{c}} \qquad ( 6 )$$

where fₐ and Tₐ are the pseudo-frequency and the pseudo-period, A is the sampling period of the signal, the parameter a is the scale of the wavelet as defined in Equation (2), and f_{c} is the center frequency in the wavelet's frequency response.

As illustrated in the spectrograms 610 and 630, daily temperature oscillations are represented by wavelets at pseudo-periods of 24 hours and greater. As illustrated in the spectrograms 620 and 640, fast irregular temperature changes are seen at pseudo-periods of smaller durations. For example, at pseudo-periods smaller than 6 hours, differences in the CWT between the weekends 530a-e and weekdays can be seen in the room temperature response illustrated in the spectrogram 620 (e.g., the room temperature response is a darker shade during the weekends 530a-e and varies between a lighter shade and a darker shade during the weekdays).

In an embodiment, the difference in wavelet magnitude between the weekends 530a-e and the weekdays of the room temperature response illustrated in the spectrogram 620 is due to the presence of occupants. For example, such patterns are observed at low pseudo-periods (e.g., see the spectrogram 620). These patterns may not be due to heat transfer through conduction from outdoor air as any oscillatory response at this time scale may not have a large enough magnitude to exceed the thermal penetration depth of the wall construction of the building. As shown in the spectrogram 640, the outdoor air temperature lacks the weekday versus the weekend 530a-e pattern. Similar to outdoor air, heat transfer through conduction from adjacent rooms may experience the same lack of thermal penetration. The heat transfer, and its effect on wavelet magnitude, can however occur from internal heat loads due to occupancy.

Thus, durations of high spectral energy (e.g., lighter shades) in the wavelet decomposition at low pseudo-periods in the spectrogram 620 may be caused by occupant presence. For example, the high spectral energy may be caused by heat generation within the room or may be caused by the transport of air into and out of the room when occupants are present. During the weekends 530a-e, little spectral energy may be measured because the room may be unoccupied, equipment may be turned off, and/or the air of the room may be more quiescent.

The above observations may be true not only for naturally ventilated rooms, but also for mechanically ventilated rooms (e.g., a room in which temperature is controlled by an HVAC system). For example, in mechanically ventilated rooms, the presence of occupants can create disturbances in the room's temperature response. However, when a mechanically ventilated room is vacant, little spectral energy at low pseudo-periods may be measured.

In an embodiment, the sensor data analyzer 410 transmits the wavelet decomposition of each sensor (or room) to the occupancy estimator 420. The occupancy estimator 420 may estimate an occupancy state of one or more rooms in a building based on the received wavelet decomposition. For example, the occupancy estimator 420 may determine that a room is in an occupied state on a specific day if the wavelet decomposition of the room indicates that the room includes more spectral energy on the specific day than what is measured (e.g., on average) during a weekend day(s). Likewise, the occupancy estimator 420 may determine that a room is not in an occupied state on a specific day if the wavelet decomposition of the room indicates that the room includes less spectral energy on the specific day than what is measured (e.g., on average) during a weekend day(s). As another example, the occupancy estimator 420 may determine that a room is in an occupied state on a specific day if the wavelet decomposition of the room indicates that the spectral energy is above a threshold value (e.g., an average amount of spectral energy measured over a day may be calculated and the room may be determined to be in an occupied state on the specific day if the spectral energy on the specific day is above the average amount, above some value greater than the average amount, etc.). Likewise, the occupancy estimator 420 may determine that a room is not in an occupied state on a specific day if the wavelet decomposition of the room indicates that the spectral energy is below a threshold value (e.g., the room may be determined not to be in an occupied state on the specific day if the spectral energy on the specific day is below the average amount, below some value less than the average amount, etc.).

The occupancy estimator 420 may determine an occupancy state for each room for which sensor data has been received. In addition, for each room, an occupancy state may be determined for each day during a given time period (e.g., a week, a month, a year, etc.).

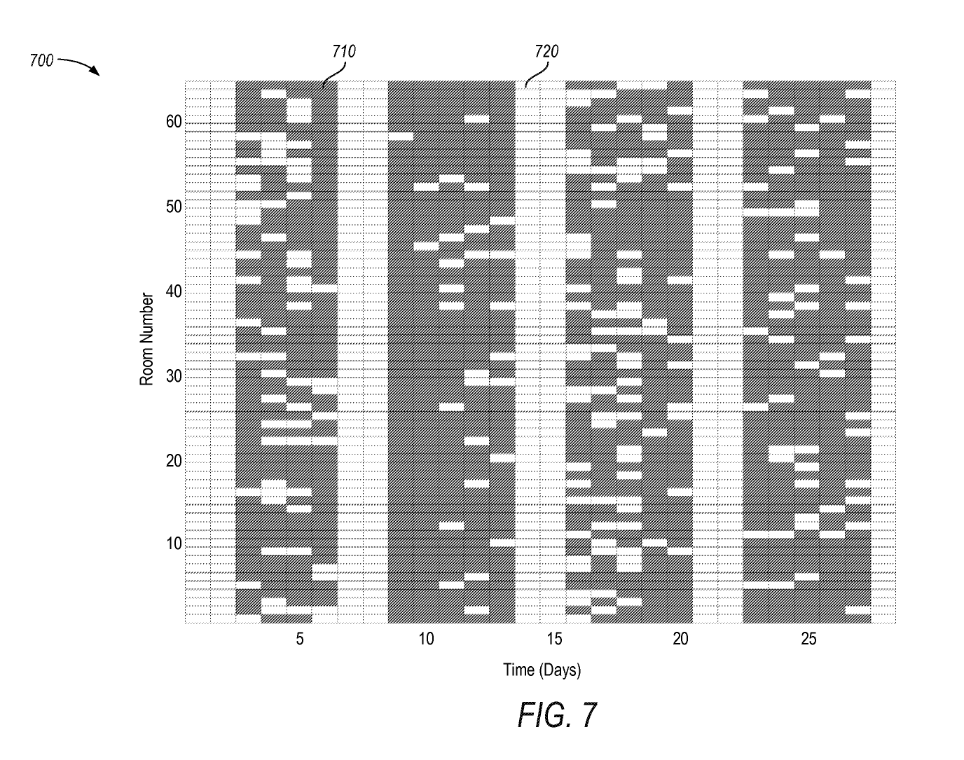

FIG. 7 illustrates an exemplary graph 700 indicating the occupancy states for sixty five rooms in a building, such as the building 101 of FIG. 1. As illustrated in FIG. 7, the occupancy states have been calculated for a four week period. The darker shades, such as box 710, indicate that a room is considered to be in an occupied state for the particular day. The lighter shades, such as box 720, indicate that a room is considered to be in an unoccupied state for the particular day. In an embodiment, the occupancy estimator 420 stores the determined occupancy states in a data repository (not shown) and/or transmits the determined occupancy states to the usage profile builder 430.

The usage profile builder 430 may generate a usage profile for a building based on the estimated occupancy states. A usage profile may capture trends observed in the estimated occupancy states. In an embodiment, the usage profile builder 430 generates an reference usage profile based on the operating hours of the building and/or observational data of occupant activity (e.g., survey data, data from surveillance systems, etc.). The usage profile builder 430 may then modify the reference usage profile using the estimated occupancy states. For example, if the estimated occupancy state for a room for a specific day indicates that the room is in an occupied state, then the reference usage profile is used for the room on the specific day. If the estimated occupancy state for a room for a specific day indicates that the room is in an unoccupied state, then the reference usage profile may be overwritten such that the room on the specific day is assumed to operate under unoccupied conditions.

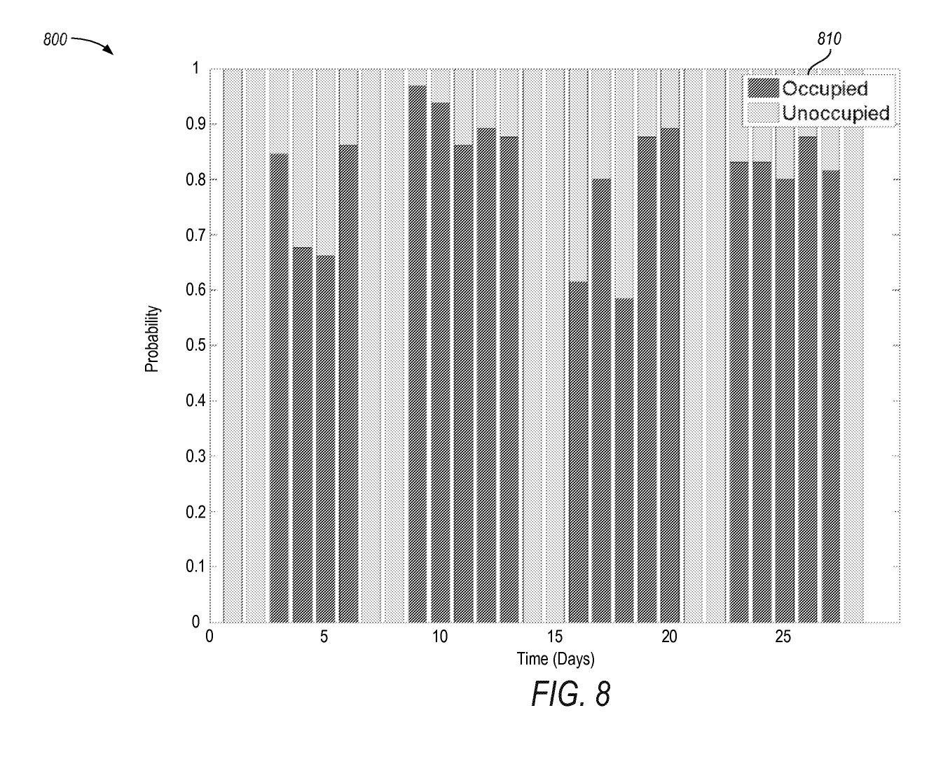

In some embodiments, sensor data is not available for one or more rooms in the building. The usage profile builder 430 may generate a probability mass function (PMF) for the rooms without sensor data. The PMF may be generated based on the estimated occupancy state. For example, the usage profile builder 430 may determine, for each individual day for which an occupancy state has been estimated, a probability that a room on the respective day may be occupied (or unoccupied). FIG. 8 illustrates an exemplary PMF 800 for the days for which an occupancy state has been estimated, as illustrated in FIG. 7. As indicated in legend 810, the darker shades in the PMF 800 indicate a probability that a room is in an occupied state on a given day and the lighter shades in the PMF 800 indicate a probability that a room is in an unoccupied state on a given day. The PMF may represent an estimated occupancy state for the rooms without sensor data. Thus, the reference usage profile may be modified using the PMF for those rooms without sensor data.

The usage profile builder 430 may transmit the generated modified usage profile to the control system 440. The control system 440 may generate commands to control equipment associated with the building and transmit those commands to the building control system 330.

Alternatively or in addition, the usage profile builder 430 may convert the generated modified usage profile into data that can be visually represented. For example, the usage profile builder 430 may determine an estimated energy usage or an estimated energy cost associated with one or more rooms or the building at a current or future time based on the generated modified usage profile. The usage profile builder 430 may generate a visual representation of such information and provide the visual representation to the visualization system 320.

### Benefits of the Modified Usage Profile

In an embodiment, the reference usage profile and the modified usage profile can be compared to show the possible benefits of using the modified usage profile. For example, electric consumption can be estimated for an existing building using the reference usage profile and the modified usage profile. The estimated electric consumptions can then be compared with the actual electric consumption of the existing building.

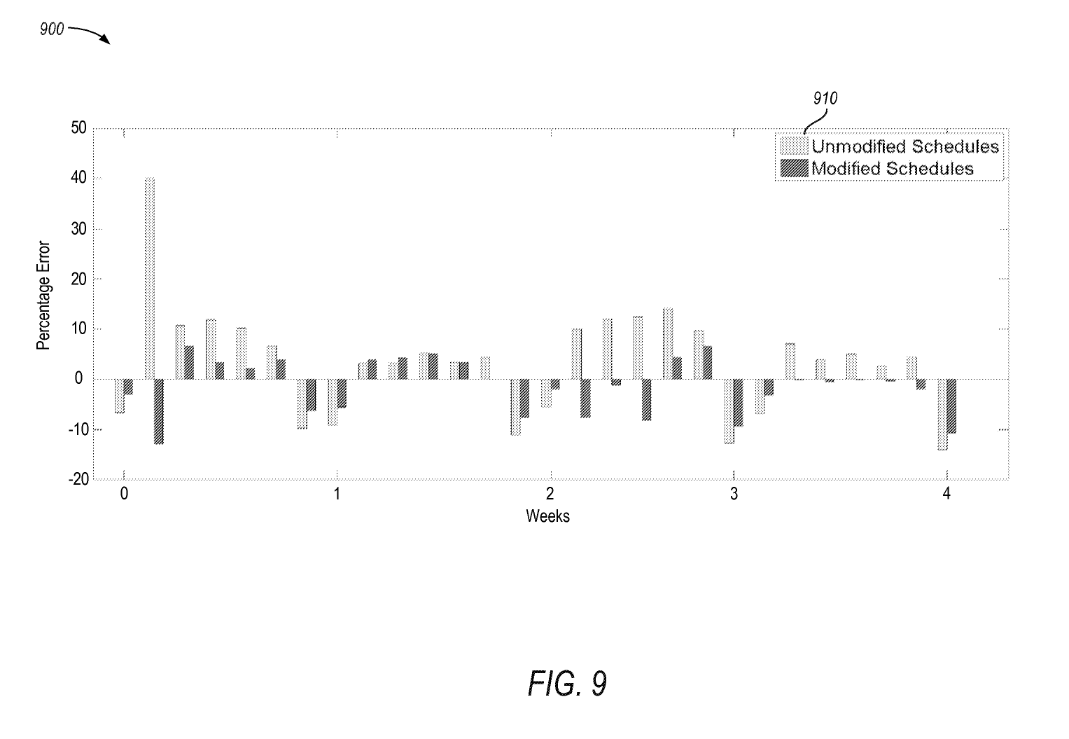

FIG. 9 illustrates an exemplary graph 900 comparing the percentage difference between the actual electric consumption and electric consumption estimated using the reference usage profile and between the actual electronic consumption and electric consumption estimated using the modified usage profile. As illustrated in FIG. 9, legend 910 indicates that the lighter shades represent the percentage error associated with the reference usage profile and the darker shades represent the percentage error associated with the modified usage profile.

To quantify the improvement in accuracy with the use of the modified usage profile, the adequacy of each model can be evaluated using ASHRAE Guideline 14-2002 (ASHRAE 2002). The ASHRAE guideline defines limits on the mean bias error (MBE) and coefficient of variation of root mean squared error (CV(RMSE)) when comparing a model prediction to measured data. The MBE and the CV(RMSE) can be represented as follows:

$$\begin{matrix}MBE ( \% ) = \frac{{Σ ( M - S )}_{hr}}{Σ {M}_{hr}} & ( 7 ) \\ CV ( RMSE ) = \frac{\sqrt{{Σ ( M - S )}_{hr}^{2} * {N}_{hr}}}{Σ {M}_{hr}} & ( 8 )\end{matrix}$$

where Mₕᵣ is hourly measured data, Sₕᵣ is hourly simulated data, and Nₕᵣ is the number of hours in the interval being compared. For a model to be declared calibrated, according to the ASHRAE guideline, the model may have an MBE below ±5% and a CV(RMSE) below ±15%. Using these metrics, the accuracy of a simulation that used the modified usage profile and the accuracy of a simulation that used the reference usage profile was determined. The MBE of the reference usage profile was 4% and the CV(RMSE) of the reference usage profile was 18.5%. On the other hand, the MBE of the modified usage profile was −0.8% and the CV(RMSE) of the modified usage profile was 10.5%. Thus, when incorporating occupancy states to the reference usage profiles, the MBE and the CV(RMSE) are both reduced and reach a level considered acceptable by the ASHRAE guideline.

### Flowchart

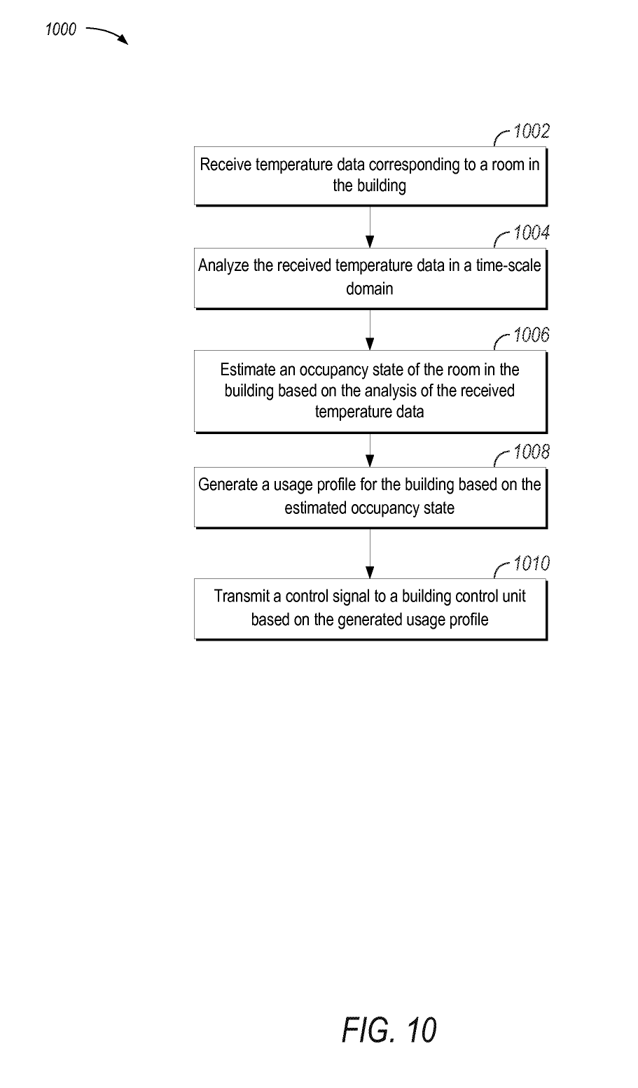

FIG. 10 illustrates a process 1000 for predicting energy usage in a building. As an example, the sensor data analysis system 310 of FIGS. 3A, 3B, and 4 can be configured to execute the process 1000. The process 1000 begins at block 1002.

At block 1002, temperature data corresponding to a room in a building is received. In an embodiment, the temperature data is captured by a sensor in the room. The temperature data may be transmitted via a wired or wireless connection to the sensor data analysis system 310.

At block 1004, the received temperature data is analyzed in a time-scale domain. In an embodiment, a CWT is generated based on the received temperature data. The CWT may indicate the spectral energy in the room for a pseudo-period of time.

At block 1006, an occupancy state of the room is estimated based on the analysis of the received temperature data. The occupancy state of the room may be estimated for at least one day. In an embodiment, the spectral energy indicated in the CWT is compared with the spectral energy (e.g., the average spectral energy) associated with rooms on the weekends to determine the occupancy state. If the spectral energy in the room on a particular day exceeds the spectral energy associated with rooms on the weekends, then the room is marked as being in an occupied state. If the spectral energy in the room on the particular day does not exceed the spectral energy associated with rooms on the weekends, then the room is marked as not being in an occupied state.

At block 1008, a usage profile is generated for the building based on the estimated occupancy state. In an embodiment, a reference usage profile is generated based on operating hours of the building and observational data of occupant activity in the building. The reference usage profile may then be modified by the estimated occupancy state to create a modified usage profile. In further embodiments, the reference usage profile is not modified if the estimated occupancy state indicates that the room is in an occupied state on a given day and the reference usage profile is modified such that the room is assumed to operate in an unoccupied state if the estimated occupancy state indicates that the room is not in an occupied state on a given day.

At block 1010, a control signal is transmitted to a building control unit based on the generated usage profile. In an embodiment, the generated usage profile can indicate whether a room in the building will be occupied at a future date. The control signal can indicate how equipment associated with the building should operate to ensure, for example, that the room is set to the appropriate temperature on the future date.

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, and/or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on general purpose computer hardware, or combinations of both. To clearly illustrate this interchangeability of hardware and software, various illustrative components, blocks, modules, and steps have been described above generally in terms of their functionality. Whether such functionality is implemented as specialized hardware versus software running on general-purpose hardware depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A method for predicting energy usage in a building, the method comprising:
as implemented by a computer system comprising one or more computing devices, the computer system configured with specific executable instructions,
receiving temperature data corresponding to a room in the building, wherein the temperature data comprises a plurality of temperature measurements taken at different respective points in time;
analyzing the received temperature data in a time-scale domain; and
estimating an occupancy state of the room in the building based on the analysis of the received temperature data, wherein the occupancy state of the room in the building indicates whether the room is occupied or vacant.

2. The method of claim 1, wherein analyzing the received temperature data comprises generating a time-frequency transformation of a temperature response of the room based on the received temperature data.

3. The method of claim 2, wherein the generated time-frequency transformation comprises an indication of a spectral energy in the room for a period of time.

4. The method of claim 3, further comprising:
identifying first spectral energy in the room on a weekend during the period of time; and
identifying second spectral energy in the room on a weekday during the period of time.

5. The method of claim 4, wherein estimating an occupancy state of the room comprises:
comparing the first spectral energy and the second spectral energy; and
identifying the room as being occupied on the weekday during the period of time in response to a determination that the first spectral energy is less than the second spectral energy.

6. The method of claim 1, further comprising:
generating a usage profile for the building based on the estimated occupancy state; and
transmitting a control signal to a building control unit based on the generated usage profile, wherein the control signal instructs the building control unit to set a temperature for the room based on a time of day.

7. The method of claim 6, further comprising generating a reference usage profile for the room based on operating hours of the building and observational data of occupant activity in the building.

8. The method of claim 7, wherein generating a usage profile for the building comprises modifying the reference usage profile based on the estimated occupancy state to generate the usage profile.

9. The method of claim 1, wherein the building comprises a second room in which second temperature data is not available.

10. The method of claim 9, further comprising:
generating a probability mass function for the second room based on the estimated occupancy state, wherein the probability mass function comprises an estimation of an occupancy state of the second room; and
generating a usage profile based on the estimated occupancy state of the room and the probability mass function for the second room.

11. The method of claim 1, wherein the building control unit comprises a heating ventilation air conditioning (HVAC) unit.

12. An electronic apparatus for predicting energy usage in a building comprising:
a computer data repository configured to store a data set, the data set comprising building sensor data, the building sensor data comprising a plurality of values captured over time for a room in the building; and
a computing system comprising one or more computing devices, the computing system in communication with the computer data repository and programmed to implement:
a sensor data analyzer configured to retrieve and analyze the building sensor data;
an occupancy estimator configured to estimate an occupancy state of the room in the building based on the analysis of the building sensor data; and
a usage profile builder configured to generate a usage profile for the building based on the estimated occupancy state.

13. The electronic apparatus of claim 12, wherein the building sensor data comprises building temperature data.

14. The electronic apparatus of claim 13, wherein the sensor data analyzer is further configured to generate a time-frequency transformation of a temperature response of the room based on the building temperature data.

15. The electronic apparatus of claim 14, wherein the generated time-frequency transformation comprises an indication of a spectral energy in the room for a period of time.

16. The electronic apparatus of claim 15, wherein the sensor data analyzer is further configured to:
identify first spectral energy in the room on a weekend during the period of time; and
identify second spectral energy in the room on a weekday during the period of time.

17. The electronic apparatus of claim 16, wherein the occupancy estimator is further configured to:
compare the first spectral energy and the second spectral energy; and
identify the room as being occupied on the weekday during the period of time in response to a determination that the first spectral energy is less than the second spectral energy.

18. The electronic apparatus of claim 12, wherein the usage profile builder is further configured to generate a reference usage profile for the room based on operating hours of the building and observational data of occupant activity in the building.

19. The electronic apparatus of claim 18, wherein the usage profile builder is further configured to modify the reference usage profile based on the estimated occupancy state to generate the usage profile.

20. The electronic apparatus of claim 12, wherein the building comprises a second room in which building sensor data is not available.

21. The electronic apparatus of claim 20, wherein the usage profile builder is further configured to generate a probability mass function for the second room based on the estimated occupancy state, wherein the probability mass function comprises an estimation of an occupancy state of the second room.

22. The electronic apparatus of claim 21, wherein the usage profile builder is further configured to generate the usage profile based on the estimated occupancy state of the room and the probability mass function for the second room.

23. The electronic apparatus of claim 12, wherein the computing system is further programmed to implement a control system configured to transmit a control signal to a building control unit based on the generated usage profile, wherein the control signal causes the building control unit to adjust a temperature of the room

24. The electronic apparatus of claim 23, wherein the building control unit comprises a heating ventilation air conditioning (HVAC) unit.

25. A computer storage system comprising a non-transitory storage device, said computer storage system having stored thereon executable program instructions that direct a computer system to at least:
receive building sensor data corresponding to a room in a building;
analyze the received building sensor data;
estimate an occupancy state of the room in the building based on the analysis of the received building sensor data;
generate a usage profile for the building based on the estimated occupancy state; and
generate a model of predicted energy consumption for the building based on the generated usage profile.

26. The computer storage system of claim 25, wherein the building sensor data comprises building temperature data.

27. The computer storage system of claim 26, wherein the executable program instructions further direct the computer system to at least generate a time-frequency transformation of a temperature response of the room based on the received temperature data.

28. The computer storage system of claim 27, wherein the generated time-frequency transformation comprises an indication of a spectral energy in the room for a period of time.

29. The computer storage system of claim 28, wherein the executable program instructions further direct the computer system to at least:
identify first spectral energy in the room on a weekend during the period of time; and
identify second spectral energy in the room on a weekday during the period of time.

30. The computer storage system of claim 29, wherein the executable program instructions further direct the computer system to at least:
compare the first spectral energy and the second spectral energy; and
identify the room as being occupied on the weekday during the period of time in response to a determination that the first spectral energy is less than the second spectral energy.

31. The computer storage system of claim 25, wherein the executable program instructions further direct the computer system to at least generate a reference usage profile for the room based on operating hours of the building and observational data of occupant activity in the building.

32. The computer storage system of claim 31, wherein the executable program instructions further direct the computer system to at least modify the reference usage profile based on the estimated occupancy state to generate the usage profile.

33. The computer storage system of claim 25, wherein the building comprises a second room in which second temperature data is not available.

34. The computer storage system of claim 33, wherein the executable program instructions further direct the computer system to at least:
generate a probability mass function for the second room based on the estimated occupancy state, wherein the probability mass function comprises an estimation of an occupancy state of the second room; and
generate the usage profile based on the estimated occupancy state of the room and the probability mass function for the second room.
